(19) United States
(12) Patent Application Publication
(10) Pub. No.: US 2024/0091916 A1
(43) Pub. Date: Mar. 21, 2024

(54) TOOL FOR INSTALLING AND DISMOUNTING THREADED FASTENER AND SOCKET ATTACHMENT

(71) Applicants: HumanIQ Co., Ltd., Gifu-ken (JP); PEC KYOKAI CO., LTD., Gifu-Ken (JP); FAMILY CO., LTD., Gifu-Ken (JP)

(72) Inventors: Kota Horie, Minokamo-shi (JP); Hitoshi Yamada, Hashima-shi (JP); Tadashi Yoshida, Kani-shi (JP)

(73) Assignees: HumanIQ Co., Ltd., Gifu-ken (JP); PEC KYOKAI CO., LTD., Gifu-Ken (JP); FAMILY CO., LTD., Gifu-Ken (JP)

(21) Appl. No.: 18/284,383

(22) PCT Filed: Feb. 22, 2022
(86) PCT No.: PCT/JP22/07414

§ 371 Date: Sep. 27, 2023

(51) Int. Cl. B25B 23/12; B25B 23/00

(52) U.S. Cl. CPC B25B 23/12; B25B 23/0035; B25B 21/00

(57) ABSTRACT

A tool includes a socket and an attachment that includes a shaft portion. The shaft portion transmits torque to the socket. The socket includes a distal end face, a proximal end face, an accommodation hole that opens in the distal end face, and a connection hole that opens in the proximal end face and is connected to the accommodation hole. The shaft portion includes an outer peripheral surface provided with a first transmission surface for transmitting torque to the inner peripheral surface of the connection hole. The accommodation hole includes an inner peripheral surface provided with a second transmission surface for transmitting torque to threaded fastener. The accommodation hole forms an accommodation space capable of accommodating threaded fasteners in a row. The shaft portion includes, at a distal end, a contact portion, which contacts one of the threaded fasteners accommodated in the accommodation space.

### TECHNICAL FIELD

The present disclosure relates to a tool for installing and dismounting a threaded fastener and a socket attachment.

### BACKGROUND ART

In the related art, for example, when a tire of an automobile is replaced, a tool such as an impact wrench or a box wrench, to which a socket is attached, is used to dismount and install nuts.

The socket can accommodate only one nut. Therefore, in a nut dismounting operation, an operator extracts a dismounted nut from the socket before dismounting the next nut. In a nut installation operation, an operator attaches one nut to the socket, install the nut, and then attach the next nut to the socket. Therefore, nut removal and installation operations are complicated.

Patent Literature 1 discloses a wheel nut wrench for automobiles that includes a tubular main body and a socket.

The tubular main body has a length capable of accommodating multiple wheel nuts. The tubular main body includes a fitting portion, to which a wheel nut is fitted, at a distal end. The tubular main body also includes a wheel nut accommodating portion between the fitting portion and a base end. The wheel nut accommodating portion has a diameter allowing wheel nuts to move freely.

The socket is detachably fitted to a base end portion of the tubular main body. In a state in which the socket is fitted to the base end portion of the tubular main body, the socket closes the wheel nut accommodating portion and rotates integrally with the tubular main body. The socket includes, at a base end portion, a connection portion, to which an output portion of an electric power tool is connected.

The wheel nut wrench disclosed in Patent Literature 1 allows an operator to dismount a nut with a nut that has already been dismounted remaining in the wheel nut accommodating portion.

### CITATION LIST

### Patent Literature

Patent Literature 1: Japanese Registered Utility Model No. 3173971

### SUMMARY OF INVENTION

### Technical Problem

Although the wheel nut wrench disclosed in Patent Literature 1 is capable of efficiently dismounting nuts, the wrench cannot efficiently install nuts.

Such a problem is not limited to a tool for installing and dismounting nuts, but also occurs in a tool for installing and dismounting bolts.

It is an objective of the present disclosure to provide a tool for installing and dismounting a threaded fastener and a socket attachment that are capable of efficiently installing and dismounting the threaded fastener.

### Solution to Problem

To achieve the foregoing objectives, a tool for installing and dismounting a threaded fastener is configured to install and dismount the threaded fastener screwed to a threaded member. The tool includes a cylindrical socket and an attachment that is inserted into the socket and includes a shaft portion that transmits torque to the socket. The socket includes a distal end face, a proximal end face, an accommodation hole that opens in the distal end face, and a connection hole that opens in the proximal end face and is connected to the accommodation hole. The shaft portion is inserted into the connection hole and includes an outer peripheral surface provided with a first transmission surface. The first transmission surface transmits the torque to an inner peripheral surface of the connection hole. The accommodation hole includes an inner peripheral surface provided with a second transmission surface. The second transmission surface is configured to transmit the torque to the threaded fastener. The accommodation hole forms an accommodation space capable of accommodating the threaded fasteners in a row in the axial direction. The shaft portion includes, at a distal end, a contact portion configured to contact the threaded fasteners accommodated in the accommodation space.

With this configuration, when the attachment is rotated about the axis of the shaft portion, the torque that rotates the attachment is transmitted to the inner peripheral surface of the connection hole of the socket via the shaft portion. The torque that rotates the socket is then transmitted to a threaded fastener such as a nut or a bolt.

This allows the threaded fastener to be dismounted by rotating the threaded fastener screwed to the threaded member counterclockwise.

When dismounting the first threaded fastener, the user adjusts the position of the attachment with respect to the socket so that the distance between the distal end face of the socket and the contact portion of the attachment is substantially equal to the length of one threaded fastener.

When dismounting the second threaded fastener, the user adjusts the position of the attachment with respect to the socket so that the distance between the distal end face of the socket and the contact portion of the attachment is substantially equal to the length of two threaded fasteners.

In this manner, the user adjusts the position of the attachment with respect to the socket in accordance with the number of threaded fasteners to be accommodated in the accommodation space inside the socket before dismounting the threaded fasteners.

The above-described configuration allows multiple threaded fasteners to be accommodated in a row in the accommodation space inside the socket. This allows the second and subsequent threaded fasteners to be dismounted with the dismounted threaded fastener accommodated in the socket.

On the other hand, a threaded fastener can be attached to the threaded member by rotating the threaded fastener clockwise.

As described above, multiple threaded fasteners can be accommodated in a row in the accommodation space inside the socket as described above. Thus, if multiple threaded fasteners are accommodated in the accommodation space, threaded fasteners do not need to be loaded into the socket one by one.

At this time, prior to installation of threaded fasteners, the user adjusts the position of the attachment with respect to the socket in accordance with the number of threaded fasteners to be accommodated in the accommodation space inside the socket.

In this manner, the above-described configuration can install or dismount multiple threaded fasteners successively. This allows threaded fasteners to be installed or dismounted efficiently.

In the above-described tool for installing and dismounting the threaded fastener, the attachment preferably includes, at a proximal end, a coupling portion configured to be detachably coupled to an output portion of a wrench.

With this configuration, torque is transmitted from the output portion of the wrench to the attachment. This allows the attachment and the socket to be easily rotated with a large torque. Therefore, the threaded fastener can be installed or dismounted more efficiently.

In the above-described tool for installing and dismounting the threaded fastener, the shaft portion preferably includes, on the outer peripheral surface, multiple marks disposed at intervals in an axial direction of the shaft portion.

With this configuration, the user easily acquires the protruding length of the shaft portion from the proximal end face of the socket, that is, the number of the threaded fasteners accommodated in the socket by visually observing the marks provided on the outer peripheral surface of the shaft portion.

In the above-described tool for installing and dismounting the threaded fastener, at least one of the socket and the contact portion preferably includes a magnetic attraction portion configured to magnetically attract the threaded fastener.

With this configuration, the threaded fastener accommodated in the socket is magnetically attracted by the magnetic force of the magnetic attraction portion. This prevents the threaded fastener from falling from the socket when, for example, the distal end face of the socket faces downward.

To achieve the foregoing objectives, a socket attachment is configured to be interposed between a cylindrical socket and an output portion of a wrench to transmit torque of the wrench to the socket. The socket is configured to install and dismount a nut to and from a threaded member. The socket includes a distal end face, a proximal end face, an accommodation hole that opens in the distal end face and is configured to accommodate the nuts in a row, and a connection hole that opens in the proximal end face and is connected to the accommodation hole. The socket attachment includes a coupling portion configured to be detachably coupled to the output portion, a shaft portion that extends in the axial direction from the coupling portion and is configured to transmit the torque to an inner peripheral surface of the connection hole by being inserted into the connection hole, and a contact portion that is provided at a distal end of the shaft portion and capable of contacting the nuts accommodated in the socket.

With this configuration, the torque from the output shaft of the wrench is transmitted to the attachment via the coupling portion, so that the attachment rotates. Then, the torque that rotates the attachment is transmitted to the inner peripheral surface of the connection hole of the socket via the shaft portion. The torque that rotates the socket is then transmitted to the nut.

This allows the nut to be dismounted by rotating the nut screwed to the threaded member counterclockwise.

When dismounting the first nut, the user adjusts the position of the attachment with respect to the socket so that the distance between the distal end face of the socket and the contact portion of the attachment is substantially equal to the length of one nut.

When dismounting the second nut, the user adjusts the position of the attachment with respect to the socket so that the distance between the distal end face of the socket and the contact portion of the attachment is substantially equal to the length of two nuts.

The above-described configuration allows multiple nuts to be accommodated in a row in the accommodation space inside the socket. This allows the second and subsequent nuts to be dismounted with the dismounted nut accommodated in the socket.

In this manner, the user adjusts the position of the attachment with respect to the socket in accordance with the number of nuts to be accommodated in the accommodation space inside the socket before dismounting the nuts.

On the other hand, a nut can be attached to the threaded member by rotating the nut clockwise.

As described above, the above-described configuration allows multiple nuts to be accommodated in a row in the accommodation space inside the socket. Thus, if multiple nuts are accommodated in the accommodation space, nuts do not need to be loaded into the socket one by one.

At this time, prior to installation of nuts, the user adjusts the position of the attachment with respect to the socket in accordance with the number of nuts to be accommodated in the accommodation space inside the socket.

In this manner, the above-described configuration can install or dismount multiple nuts successively. This allows nuts to be installed or dismounted efficiently.

### Advantageous Effects of Invention

The present invention allows threaded fasteners to be installed or dismounted efficiently.

### BRIEF DESCRIPTION OF DRAWINGS

FIG. 1 is an exploded perspective view of a socket and an attachment that form an installing and dismounting tool according to one embodiment.

FIG. 2 is a cross-sectional view of the installing and dismounting tool shown in FIG. 1.

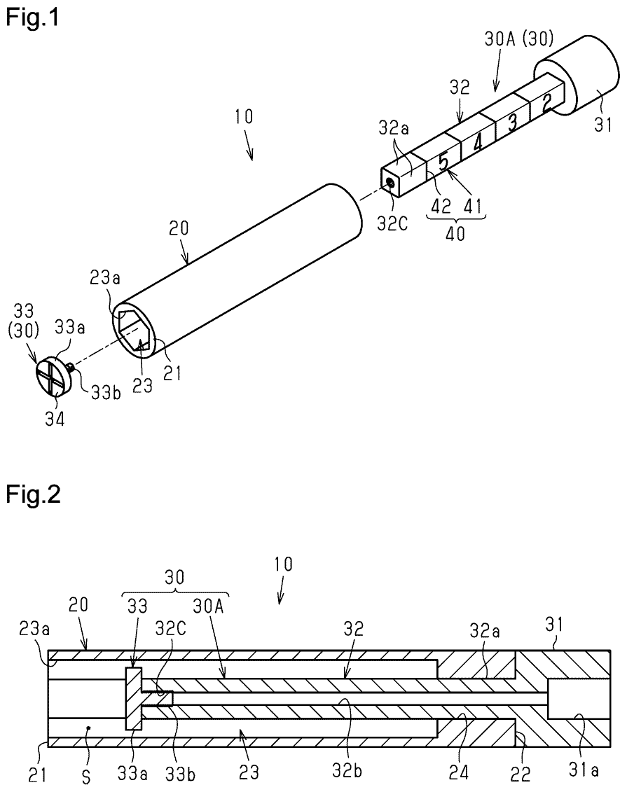

FIG. 1.

FIG. 3 is a front view of a distal end face of the socket shown in FIG. 1.

FIG. 4 is a front view of a proximal end face of the socket shown in FIG. 1.

FIGS. 5A and 5B are side views of the attachment main body shown in FIG. 1.

FIG. 6 is a front view of a proximal end face of the attachment main body shown in FIG. 1.

FIGS. 7A and 7B are cross-sectional views of the installing and dismounting tool shown in FIG. 1 when attached to a wrench.

FIGS. 8A and 8B are cross-sectional views of the installing and dismounting tool shown in FIG. 1 when attached to a wrench.

FIG. 9 is a side view of an installing and dismounting tool according to a modification.

### DESCRIPTION OF EMBODIMENTS

A tool for installing and dismounting a threaded fastener and a socket attachment according to one embodiment will now be described with reference to FIGS. 1 to 8B.

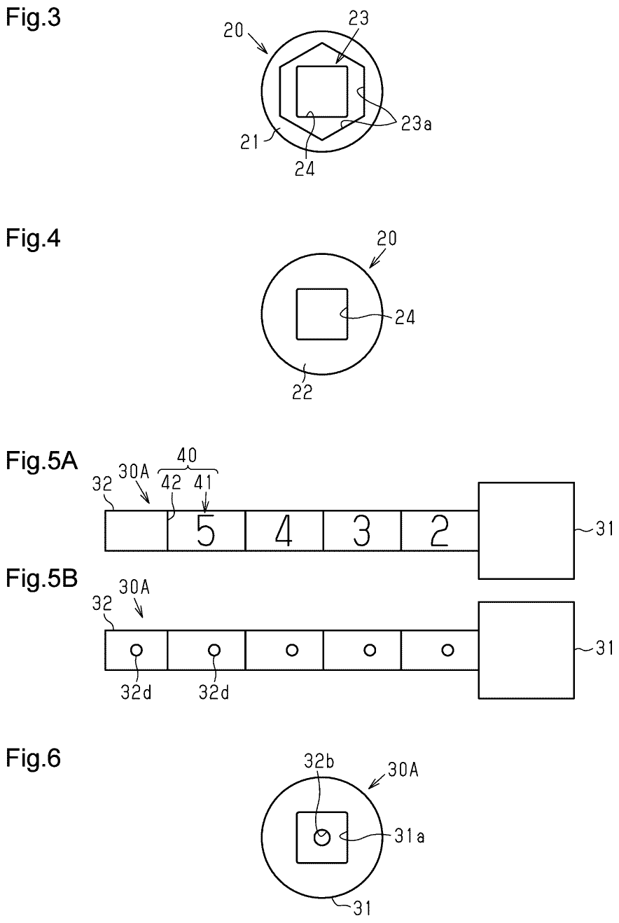

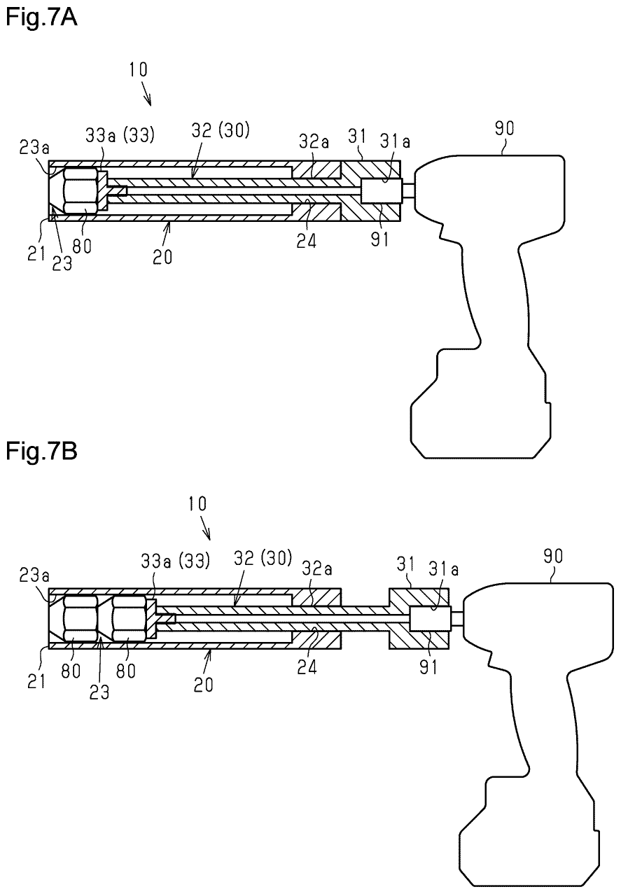

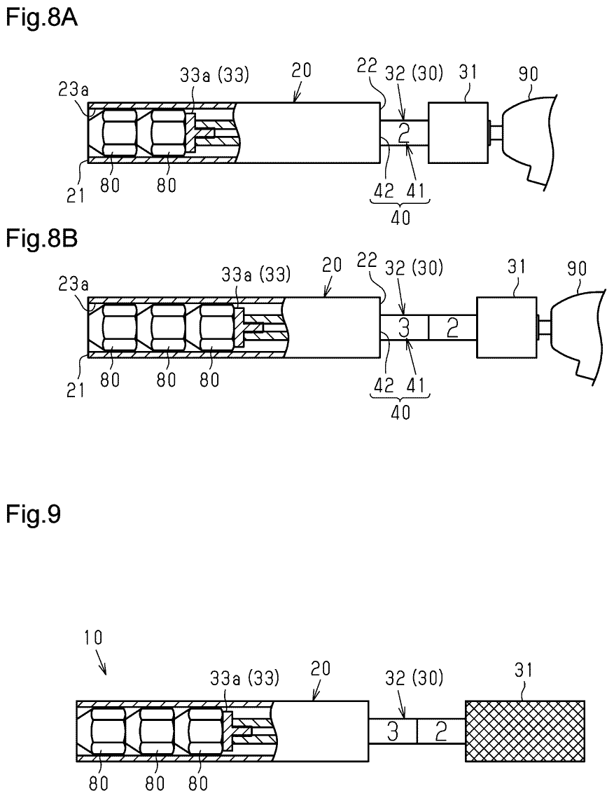

As shown in FIGS. 1 and 2, a tool for installing and dismounting a threaded fastener (hereinafter, referred to as a tool 10) installs and dismounts a threaded fastener to be screwed to a threaded member (neither is shown). The threaded fastener of the present embodiment is a metal nut 80. The cross-sectional shape of the outer peripheral surface of the nut 80 is a substantially regular hexagon (see FIGS. 7A to 8B).

The tool 10 includes a tubular socket 20 and an attachment 30, which is inserted into the socket 20 and includes a shaft portion 32 for transmitting torque to the socket 20.

Next, each component of the tool 10 will be described in detail.

<Socket 20>

As shown in FIGS. 1 and 2, the socket 20 has, for example, a circular cross-sectional shape. The socket 20 includes a distal end face 21 and a proximal end face 22. The socket 20 includes an accommodation hole 23 that opens in the distal end face 21, and a connection hole 24 that opens in the proximal end face 22 and is connected to the accommodation hole 23.

As shown in FIGS. 1 to 3, the cross-sectional shape of the accommodation hole 23 is a regular hexagon centered on the axis of the socket 20. The inner peripheral surface of the accommodation hole 23 includes a second transmission surface 23a, which transmits torque to the nut 80.

The accommodation hole 23 forms an accommodation space S capable of accommodating nuts 80 in a row in the axial direction. The accommodation space S has a length capable of accommodating, for example, five nuts 80 in a row.

As shown in FIGS. 2 to 4, the cross-sectional shape of the connection hole 24 is a square centered on the axis of the socket 20.

The socket 20 is made of, for example, metal.

<Attachment 30>

As shown in FIGS. 1, 2, 7A, and 7B, the attachment 30 is interposed between the socket 20 and an output portion 91 of a wrench 90 to transmit torque of the wrench 90 to the socket 20. The wrench 90 is, for example, an electric impact wrench. The output portion 91, for example, has the shape of a quadrangular prism. The cross-sectional shape of the output portion 91 is a substantially square centered on the axis of the output portion 91. The output portion 91 is rotated about the axis of the output portion 91.

As shown in FIGS. 1 and 2, an attachment main body 30A and a contact member 33 are provided. The attachment main body side 30A and the contact member 30 are made of metal, for example.

The attachment main body 30A includes a coupling portion 31 and a shaft portion 32.

The coupling portion 31 is located at the proximal end of the attachment main body 30A. The coupling portion 31 has, for example, a cylindrical shape. The coupling portion 31 has, for example, the same outer diameter as the socket 20. The outer diameter of the coupling portion 31 may be different from the outer diameter of the socket 20.

The coupling portion 31 includes, in the proximal end face, a recess 31a, to which the output portion 91 of the wrench 90 is detachably coupled.

As shown in FIG. 6, the cross-sectional shape of the recess 31a is a square centered on the axis of the shaft portion 32.

As shown in FIGS. 1 and 2, the shaft portion 32 extends from the distal end face of the coupling portion 31. The shaft portion 32 is provided on the same axis as the coupling portion 31.

The shaft portion 32 is inserted into the connection hole 24 of the socket 20. The shaft portion 32 includes, on the outer peripheral surface, a first transmission surface 32a, which transmits torque to the inner circumferential surface of the connection hole 24.

The shaft portion 32, for example, has the shape of a quadrangular prism. The cross-sectional shape of the shaft portion 32 is, for example, a square centered on the axis of the socket 20. In this case, the outer peripheral surface of the shaft portion 32 is formed by four surfaces. The first transmission surface 32a includes the four surfaces described above. The length of one side of the cross section of the shaft portion 32 is slightly less than the length of one side of the cross section of the connection hole 24.

As shown in FIG. 2, the shaft portion 32 includes a center hole 32b extending through the shaft portion 32 in the axial direction of the shaft portion 32. The center hole 32b is open in the bottom surface of the recess 31a. The center hole 32b includes an internal thread portion 32c at the distal end portion.

As shown in FIGS. 1 and 5A, the shaft portion 32 includes multiple marks 40 on the outer peripheral surface at intervals in the axial direction of the shaft portion 32.

The marks 40 include, for example, numeral portions 41, which display Arabic numerals “2”, “3”, “4”, and “5”, and line portions 42, which are each located between the numeral portions 41 adjacent to each other and extend along the circumferential direction of the shaft portion 32.

The numbers “2”, “3”, “4”, and “5”, which form the numeral portions 41, are provided in that order from the proximal side of the shaft portion 32. The numeral portions 41 are provided on one surface forming the outer peripheral surface of the shaft portion 32, for example.

The line portions 42 extend over the entire circumference of the outer peripheral surface of the shaft portion 32, for example.

The marks 40 are preferably recessed in the outer peripheral surface of the shaft portion 32.

As shown in FIGS. 1 and 2, the contact member 33 includes a contact portion 33a and a screw shaft 33b.

The contact portion 33a has the shape of a disc. The outer diameter of the contact portion 33a is set such that the contact portion 33a does not contact the inner peripheral surface of the accommodation hole 23 of the socket 20.

The screw shaft 33b protrudes from the center of the proximal end face of the contact portion 33a. The screw shaft 33b is formed integrally with the contact portion 33a.

A magnetic attraction portion 34 for magnetically attracting one or more nuts 80 is provided on the distal end face of the contact portion 33a. The magnetic attraction portion 34 is formed by magnetizing the distal end face of the contact portion 33a.

As shown in FIG. 2, the contact portion 33a is provided at the distal end of the shaft portion 32 by screwing the screw shaft 33b into the internal thread portion 32c of the shaft portion 32. The distal end face of the contact portion 33a is contactable with the nut 80 accommodated in the accommodation space S.

As shown in FIG. 5B, the shaft portion 32 includes multiple projections 32d on the outer peripheral surface at intervals in the axial direction of the shaft portion 32. The projections 32d are each located between the line portions 42 adjacent to each other. The projections 32d are provided on one surface forming the outer peripheral surface of the shaft portion 32. The projections 32d are provided on a surface of the outer peripheral surface different from the surface on which the numeral portions 41 are provided.

One of the projections 32d is pressed against the inner peripheral surface of the connection hole 24 of the socket 20. This prevents the socket 20 from falling off the attachment 30 under its own weight.

Operation of the present embodiment will now be described.

As shown in FIG. 7A, the torque from the output portion 91 of the wrench 90 is transmitted to the attachment 30 via the coupling portion 31 to rotate the attachment 30. Then, the torque that rotates the attachment 30 is transmitted to the inner peripheral surface of the connection hole 24 of the socket 20 via the shaft portion 32. The torque that rotates the socket 20 is then transmitted to the nut 80.

This allows the nut 80 to be dismounted by rotating the nut 80 screwed to a threaded member counterclockwise.

When dismounting the first nut 80, the user adjusts the position of the attachment 30 with respect to the socket 20 so that the distance between the distal end face 21 of the socket 20 and the contact portion 33a of the attachment 30 is substantially equal to the length of one nut 80.

When dismounting the second nut 80 as shown in FIG. 7B, the user adjusts the position of the attachment 30 with respect to the socket 20 so that the distance between the distal end face 21 of the socket 20 and the contact portion 33a of the attachment 30 is substantially equal to the length of two nuts 80.

At this time, as shown in FIG. 8A, the user easily acquires the protruding length of the shaft portion 32 from the proximal end face 22 of the socket 20, that is, the number of the nuts 80 accommodated in the socket 20, by visually observing the marks 40 provided on the outer peripheral surface of the shaft portion 32. Specifically, the user can recognize that the number of the nuts 80 is two by visually observing “2” of the numeral portion 41. In addition, the user adjusts the protruding length of the shaft portion 32 so that the line portion 42 adjacent to “2” on the side closer to the distal end agrees with the proximal end face 22 of the socket 20.

When dismounting the third nut 80 as shown in FIG. 8B, the user adjusts the position of the attachment 30 with respect to the socket 20 so that the distance between the distal end face 21 of the socket 20 and the contact portion 33a of the attachment 30 is substantially equal to the length of three nuts 80.

At this time, the user easily acquires the protruding length of the shaft portion 32 from the proximal end face 22 of the socket 20, that is, the number of the nuts 80 accommodated in the socket 20, by visually observing the marks 40 provided on the outer peripheral surface of the shaft portion 32. Specifically, the user can recognize that the number of the nuts 80 is three by visually observing “3” of the numeral portion 41. In addition, the user adjusts the protruding length of the shaft portion 32 so that the line portion 42 adjacent to “3” on the side closer to the distal end agrees with the proximal end face 22 of the socket 20.

In this manner, the user adjusts the position of the attachment 30 with respect to the socket 20 in accordance with the number of nuts 80 to be accommodated in the accommodation space S inside the socket 20 before dismounting the nuts 80.

The tool 10 of the present embodiment allows multiple nuts 80 to be accommodated in a row in the accommodation space S inside the socket 20. This allows the second and subsequent nuts 80 to be dismounted with the dismounted nut 80 accommodated in the socket 20.

On the other hand, a nut 80 can be attached to the threaded member by rotating the nut 80 clockwise. When the nut 80 is attached to the threaded member, the screw thread may be cut if the nut 80 is obliquely engaged with the threaded member. Therefore, to avoid such a problem, it is preferable that the tool 10 alone be manually rotated until the nut 80 is engaged with the threaded member in a proper position.

As described above, the tool 10 of the present embodiment allows multiple nuts 80 to be accommodated in a row in the accommodation space S inside the socket 20. Thus, if multiple nuts 80 are accommodated in the accommodation space S, nuts 80 do not need to be loaded into the socket 20 one by one.

At this time, prior to installation of nuts 80, the user adjusts the position of the attachment 30 with respect to the socket 20 in accordance with the number of nuts 80 to be accommodated in the accommodation space S inside the socket 20.

In this manner, the tool 10 of the present embodiment can install or dismount multiple nuts 80 successively. This allows nuts 80 to be installed or dismounted efficiently.

The present embodiment has the following advantages.

(1) The tool 10 includes the socket 20 and the attachment 30. The socket 20 includes the distal end face 21, the proximal end face 22, the accommodation hole 23, and the connection hole 24. The shaft portion 32 is inserted into the connection hole 24 and includes an outer peripheral surface provided with the first transmission surface 32a, which transmits torque to the inner peripheral surface of the connection hole 24. The accommodation hole 23 includes an inner peripheral surface provided with the second transmission surface 23a, which transmits torque to the nut 80. The accommodation hole 23 forms the accommodation space S, which is capable of accommodating nuts 80 in a row in the axial direction. The shaft portion 32 includes, at the distal end, the contact portion 33a, which contacts a nut 80 accommodated in the accommodation space S.

The above-described configuration operates in the above-described manner. The nuts 80 therefore can be installed or dismounted efficiently.

(2) The attachment 30 includes, at the proximal end, the coupling portion 31 configured to be detachably coupled to the output portion 91 of the wrench 90.

With this configuration, torque is transmitted from the output portion 91 of the wrench 90 to the attachment 30. This allows the attachment 30 and the socket 20 to be easily rotated with a large torque. Therefore, the nuts 80 can be installed or dismounted more efficiently.

(3) The shaft portion 32 includes the multiple marks 40 on the outer peripheral surface at intervals in the axial direction of the shaft portion 32.

With this configuration, the user easily acquires the protruding length of the shaft portion 32 from the proximal end face 22 of the socket 20, that is, the number of the nuts 80 accommodated in the socket 20, by visually observing the marks 40 provided on the outer peripheral surface of the shaft portion 32.

(4) The magnet 34 is provided at the contact portion 33a.

With this configuration, one or more nuts 80 accommodated in the socket 20 are magnetically attracted by the magnetic force of the magnet 34. This prevents the nuts 80 from falling from the socket 20 when, for example, the distal end face 21 of the socket 20 faces downward.

(5) The attachment 30 includes the coupling portion 31 and the shaft portion 32. The coupling portion 31 is detachably coupled to the output portion 91. The shaft portion 32 extends from the coupling portion 31 and is inserted into the connection hole 24 to transmit torque to the inner peripheral surface of the connection hole 24. The attachment 30 includes the contact portion 33a, which is provided at the distal end of the shaft portion 32 and capable of contacting the nut 80 accommodated in the socket 20.

(6) The shaft portion 32 is inserted into the connection hole 24 and includes the first transmission surface 32a, which transmits torque to the inner peripheral surface of the connection hole 24. Therefore, the shape of the outer peripheral surface of the socket 20 is not restricted in transmitting the torque of the shaft portion 32 to the socket 20. This adds to the flexibility in the shape of the outer peripheral surface of the socket 20.

<Modifications>

The above-described embodiment may be modified as follows. The above-described embodiment and the following modifications can be combined as long as the combined modifications remain technically consistent with each other.

Instead of or in addition to the contact portion 33a, the socket 20 may be provided with the magnetic attraction portion 34. In addition, the magnetic attraction portion 34 is not limited to one that is formed by magnetizing the contact portion 33a or the like. A magnet may be provided as the magnetic attraction portions 34 on at least one of the distal end face of the contact portion 33a and the inner peripheral surface of the accommodation hole 23 of the socket 20.

The magnetic attraction portion 34 may be omitted. In this case, locking balls for locking one or more nuts 80 may be provided on the inner peripheral surface of the distal end portion of the accommodation hole 23. In this case, it is preferable that the locking balls be arranged at intervals in the circumferential direction of the socket 20.

The numeral portions 41 or the line portions 42 may be omitted.

The marks 40 may be omitted.

An air-driven impact wrench can also be used as the wrench 90. Alternatively, a manual wrench such as a ratchet wrench may be used. When the wrench 90 is not used, the recess 31a of the coupling portion 31 may be omitted.

The cross-sectional shape of the connection hole 24 is not limited to a square centered on the axis of the socket 20, and may be another polygonal shape such as a regular hexagon. In this case, the cross-sectional shape of the shaft portion 32 may be changed in accordance with the cross-sectional shape of the connection hole 24.

As shown in FIG. 9, the coupling portion 31 may be provided with a fine recesses and protrusions on the outer peripheral surface. In this case, when the user grips the coupling portion 31 and manually rotates the tool 10 alone, the hand is prevented from slipping.

The attachment main body side 30A and the contact member 30 may be made of hard plastic.

The socket 20 may be made of hard plastic.

The threaded fastener is not limited to the nut 80 and may be a bolt.

“Tubular” shapes as used in the present description include any structure having a peripheral wall. For example, “tubular” shapes include but are not limited to any structure having circular cross-sectional shape, an elliptic cross-sectional shape, and a polygonal cross-sectional shape with sharp or rounded corners.

### REFERENCE SIGNS LIST

10 . . . Tool
20 . . . Socket
21 . . . Distal End Face
22 . . . Proximal End Face
23 . . . Accommodation Hole
23a . . . Second Transmission Surface
24 . . . Connection Hole
30 . . . Attachment
30A . . . Attachment Main Body
31 . . . Coupling Portion
31a . . . Recess
32 . . . Shaft Portion
32a . . . Second Transmission Surface
32b . . . Center Hole
32c . . . Internal Thread Portion
32d . . . Projections
33 . . . Contact Member
33a . . . Contact Portion
33b . . . Screw Shaft
34 . . . Magnetic Attraction Portion
40 . . . Marks
41 . . . Numeral Portions
42 . . . Line Portions
80 . . . Nut (Threaded Fastener)
90 . . . Wrench
91 . . . Output Shaft

1. A tool for installing and dismounting a threaded fastener, the tool being configured to install and dismount the threaded fastener to and from a threaded member, the tool comprising:
a cylindrical socket; and
an attachment that is inserted into the socket and includes a shaft portion that transmits torque to the socket, wherein
the socket includes:
a distal end face;
a proximal end face;
an accommodation hole that opens in the distal end face; and
a connection hole that opens in the proximal end face and is connected to the accommodation hole,
the shaft portion is inserted into the connection hole and includes an outer peripheral surface provided with a first transmission surface, the first transmission surface transmitting the torque to an inner peripheral surface of the connection hole,
the accommodation hole includes an inner peripheral surface provided with a second transmission surface, the second transmission surface being configured to transmit the torque to the threaded fastener,
the threaded fastener is one of threaded fasteners, and the accommodation hole forms an accommodation space capable of accommodating the threaded fasteners in a row in an axial direction of the socket, and
the shaft portion includes, at a distal end, a contact portion configured to contact one of the threaded fasteners accommodated in the accommodation space.

2. The tool for installing and dismounting the threaded fastener according to claim 1, wherein the attachment includes, at a proximal end, a coupling portion configured to be detachably coupled to an output portion of a wrench.

3. The tool for installing and dismounting the threaded fastener according to claim 1, wherein the shaft portion includes, on the outer peripheral surface, multiple marks disposed at intervals in an axial direction of the shaft portion.

4. The tool for installing and dismounting the threaded fastener according to claim 1, wherein at least one of the socket and the contact portion includes a magnetic attraction portion configured to magnetically attract the threaded fastener.

5. A socket attachment that is configured to be interposed between a cylindrical socket and an output portion of a wrench to transmit torque of the wrench to the socket, wherein
the socket is configured to install and dismount a nut to and from a threaded member,
the nut is one of nuts, and the socket includes:
a distal end face;
a proximal end face;
an accommodation hole that opens in the distal end face and is configured to accommodate the nuts in a row; and
a connection hole that opens in the proximal end face and is connected to the accommodation hole,
the socket attachment comprises:
a coupling portion configured to be detachably coupled to the output portion;
a shaft portion that extends in an axial direction of the socket from the coupling portion and is configured to transmit the torque to an inner peripheral surface of the connection hole by being inserted into the connection hole; and
a contact portion that is provided at a distal end of the shaft portion and capable of contacting one of the nuts accommodated in the socket.
